(19) United States
(12) Patent Application Publication
(10) Pub. No.: US 2026/0205485 A1
(43) Pub. Date: Jul. 16, 2026

(54) GRAPH ANOMALY DETECTION SYSTEM AND METHOD USING AVERAGE CONTROLLABILITY

(71) Applicant: VANDERBILT UNIVERSITY, Nashville, TN (US)

(72) Inventors: Xenofon Koutsoukos, Nashville, TN (US); Anwar Said, Nashville, TN (US); Yifan Wei, Nashville, TN (US)

(21) Appl. No.: 19/449,778

(22) Filed: Jan. 15, 2026

Related U.S. Application Data
(60) Provisional application No. 63/745,555, filed on Jan. 15, 2025.

(51) Int. Cl. H04L 9/40

(52) U.S. Cl. CPC H04L 63/1425

(57) ABSTRACT

An exemplary system and method are disclosed for determining anomalies in a trained graph neural network model using average controllability metrics determined via a Gramian operator for node influence and control in the network. The trained graph neural network is trained using (i) network data constructed with average controllability-derived metrics as an edge weight or (ii) encoding average controllability as a one-hot edge attribute vector, which enhances the observability and/or performance of the graph neural network in assessing anomalies in the influence of a node in the network. By integrating average controllability into graph-based networks using either (i) average controllability as an edge weight or (ii) encoding average controllability as a one-hot edge attribute vector, the exemplary system and method can determine a node's influence, quantified by average controllability, to improve anomaly detection.

### RELATED APPLICATION

This U.S. Application claims priority to, and the benefit of, U.S. Provisional Patent Application No. 63/745,555, filed Jan. 15, 2025, which is incorporated by reference herein in its entirety.

### GOVERNMENT SPONSORSHIP CLAUSE

This invention was made with government support under Grant No. 2325417, awarded by the National Science Foundation. The government has certain rights in the invention.

### BACKGROUND

Graph anomaly detection are employed in applications in social network analysis, fraud detection, cybersecurity, and healthcare, e.g., in cybersecurity for intrusion detection, financial fraud detection, social network analysis for bogus account identification, and healthcare anomaly detection. Graph Anomaly Detection (GAD) allows for the identification of anomalous patterns or outliers in graph-structured data. Anomalies can manifest as irregularities in the structure or attributes of nodes and edges, which may indicate significant, often hidden events, such as fraud and network intrusions.

Current methods for anomaly detection struggle to capture the complexity and the topology of the graph, making it challenging to accurately model relationships and interactions.

There is a benefit to improving the system and method for graph anomaly detection.

### SUMMARY

An exemplary system and method are disclosed for determining anomalies in a trained graph neural network model using average controllability metrics determined via a Gramian operator for node influence and control in the network. The trained graph neural network is trained using (i) network data constructed with average controllability-derived metrics as an edge weight or (ii) encoding average controllability as a one-hot edge attribute vector, which enhances the observability and/or performance of the graph neural network in assessing anomalies in the influence of a node in the network. By integrating average controllability into graph-based networks using either (i) average controllability as an edge weight or (ii) encoding average controllability as a one-hot edge attribute vector, the exemplary system and method can determine a node's influence, quantified by average controllability, to improve anomaly detection.

Controllability is a concept in network control theory that has gained attention in graph representation learning and graph anomaly detection. The controllability properties of dynamical networks can be used to develop expressive and efficient graph representations for downstream anomaly detection tasks. For example, controllability properties can be employed to create augmented graph structures for contrastive learning. By perturbing the graph while preserving its controllability, augmented graphs that retain key structural characteristics can be generated, leading to better performance in anomaly classification tasks. Graphs can also be configured as networked dynamical systems, in which controllability is used to analyze the relationship between the graph's topology and its control behavior. By utilizing metrics such as the controllability Gramian, new graph representations can be configured to capture both local and global structural information. The representations can exhibit desirable properties like permutation and scale invariance, enabling more robust and interpretable embeddings for graph classification.

In some implementations, the exemplary system and method may encode controllability values into nodes as edge weights, assigning weights directly to reflect the control influence of each connection. In other implementations, the exemplary system and method may encode controllability value into nodes as edge attributes using rank encoding, capturing the importance of edges in terms of their ability to control the network in an attributed form.

The exemplary system and method, which use controllability values to reflect and capture the control influence of each connection or network edge, may help detect graph anomalies, unusual patterns, or outliers in graph-structured networks (e.g., neural networks, internet networks). These anomalies, if undetected, may manifest as irregularities in the structure or attributes of nodes and edges in networks, resulting in significant, often hidden events such as fraud, network intrusion, or irregular user behavior. Therefore, the exemplary system and method may prevent fraud, network intrusion, or irregularities by early detection of anomalies in the network.

In an aspect, a method is disclosed comprising receiving, by a processor, data for a network system; generating, by the processor, a graph using the data, wherein the graph contains a set of nodes connected by a set of edges as defined by the network system; generating a modified graph for input to a trained anomaly detector by generating, by the processor, a set of average controllability score values for the set of nodes, wherein each node of the set of nodes is assigned a generated average controllability score value, and wherein each average controllability score value defines control influence of a respective node in the graph based on a Gramian operator; generating, by the processor, one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node; and assigning, by the processor, the set of average controllability score values for the set of nodes and the one or more encodings for the set of edges to the graph to generate a modified graph; applying, by the processor, the modified graph as input to the trained anomaly detector including a graph neural network, wherein the trained anomaly detector is configured to detect an anomaly based on at least one of average controllability score and/or encoding, and wherein the anomaly indicates presence or non-presence of an anomaly in the network system; and outputting, by the processor, an indication of an anomaly in the network system based on the output of the trained anomaly detector.

In some embodiments, the edge weight values for the set of edges are generated by: adjusting, by the processor, the set of generated average controllability score values using a scaling operator (e.g., to apply an offset or scale); and determining, by the processor, a weight value for each edge in the set of edges using a controllability score value of a node of the edge.

In some embodiments, the edge attribute values for the set of edges are generated by generating, by the processor, a histogram object corresponding to a distribution of occurrence of specific average controllability score values determined across a set of steps for at least a change in state transition assessed using the Gramian operator; and determining, by the processor, an edge feature matrix for the set of edges by applying a rank encoding operator (e.g., one-hot encoding operator) based on if the average controllability of one or more source nodes resides in a corresponding edge.

In some embodiments, the histogram object has a plurality of bins, wherein each bin has: (i) a width representing a range of controllability values, and (ii) a height representing a frequency of nodes whose controllability score value falls within said range.

In some embodiments, the attribute vector for each edge is formed by applying one-hot encoding to a node (e.g., source node) of the edge.

In some embodiments, the generating the set of controllability score values including determining, by the processor, an adjacency matrix object of the graph; determining, by the processor, a largest absolute eigenvalue for the adjacency matrix object; generating, by the processor, a normalized adjacency matrix object using the largest absolute eigenvalue and an identity matrix object; and generating, by the processor, a controllability (e.g., Gramian) matrix object, wherein the controllability matrix object has diagonal entries forming the set of controllability score values.

In some embodiments, the data for a network system includes bank account information in a banking network system, blockchain account in a blockchain network system, computing device in an Internet network system, computing device in a local area or wide area computer network system, vehicle in a transportation network system, and user account in a social network system.

In another aspect, a method to generate the trained anomaly detector is disclosed comprising receiving, by a processor, a graph containing a set of nodes connected by a set of edges for a set of example network systems having labeled data associated with an anomaly (e.g., fraud, malware); generating, by the processor, a set of average controllability score values for the set of nodes, wherein each node of the set of nodes is assigned a generated average controllability score value, and wherein each average controllability score value defines control influence of a respective node in the graph based on a Gramian operator; generating, by the processor, one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node; assigning, by the processor, the set of average controllability score values for the set of nodes and the one or more encodings for the set of edges to the graph to generate a modified graph; and applying, by the processor, (i) the modified graph as input to an anomaly detector including a graph neural network and (ii) the labeled data as training data to the anomaly detector.

In some embodiments, the edge attribute value is evaluated bidirectionally in relation to the source node.

In another aspect, a system is disclosed comprising: a processor; and a memory having instructions stored thereon, wherein execution of the instructions causes the processor to: receive data for a network system; generate a graph using the data, wherein the graph contains a set of nodes connected by a set of edges as defined by the network system; generate a modified graph for input to a trained anomaly detector by: generating a set of average controllability score values for the set of nodes, wherein each node of the set of nodes is assigned a generated average controllability score value, and wherein each average controllability score value defines control influence of a respective node in the graph based on a Gramian operator; generating one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node; and assigning the set of average controllability score values for the set of nodes and the one or more encodings for the set of edges to the graph to generate a modified graph; apply the modified graph as input to the trained anomaly detector including a graph neural network, wherein the trained anomaly detector is configured to detect an anomaly based on at least one of average controllability score and/or encoding, and wherein the anomaly indicates presence or non-presence of an anomaly in the network system; and output an indication of an anomaly in the network system based on the output of the trained anomaly detector.

In some embodiments, instructions to generate the edge weight values for the set of edges, when executed, cause the processor to: adjust the set of generated average controllability score values using a scaling operator (e.g., to apply an offset or scale); and determine a weight value for each edge in the set of edges using a controllability score value of a node of the edge.

In some embodiments, instructions to generate the edge attributes for the set of edges, when executed, cause the processor to: generate a histogram object corresponding to a distribution of occurrence of specific average controllability score values determined across a set of steps for at least a change in state transition assessed using the Gramian operator; and determine an edge feature matrix for the set of edges by applying a rank encoding operator (e.g., one-hot encoding operator) based on if the average controllability of one or more source nodes resides in a corresponding edge.

In some embodiments, the edge attribute for each edge is formed by applying one-hot encoding to a node (e.g., source node) of the edge.

In some embodiments, instructions to generate the set of controllability score values, when executed, cause the processor to: determine an adjacency matrix object of the graph; determine a largest absolute eigenvalue for the adjacency matrix object; generate a normalized adjacency matrix object using the largest absolute eigenvalue and an identity matrix object; and generate a controllability (e.g., Gramian) matrix object, wherein the controllability matrix object has diagonal entries forming the set of controllability score values.

In some embodiments, instructions to generate the trained anomaly detector, when executed, cause the processor to: receive a graph containing a set of nodes connected by a set of edges for a set of example network systems having labeled data associated with an anomaly (e.g., fraud, malware); generate a set of average controllability score values for the set of nodes, wherein each node of the set of nodes is assigned a generated average controllability score value, and wherein each average controllability score value defines control influence of a respective node in the graph based on a Gramian operator; generate one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node; assign the set of average controllability score values for the set of nodes and the one or more encodings for the set of edges to the graph to generate a modified graph; and apply (i) the modified graph as input to an anomaly detector including a graph neural network and (ii) the labeled data as training data to the anomaly detector.

In yet another aspect, a non-transitory computer-readable medium having instructions stored thereon is disclosed, wherein execution of the instructions causes a processor to: receive data for a network system; generate a graph using the data, wherein the graph contains a set of nodes connected by a set of edges as defined by the network system; generate a modified graph for input to a trained anomaly detector by: generating a set of average controllability score values for the set of nodes, wherein each node of the set of nodes is assigned a generated average controllability score value, and wherein each average controllability score value defines control influence of a respective node in the graph based on a Gramian operator; generating one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node; and assigning the set of average controllability score values for the set of nodes and the one or more encodings for the set of edges to the graph to generate a modified graph; apply the modified graph as input to the trained anomaly detector including a graph neural network, wherein the trained anomaly detector is configured to detect an anomaly based on at least one of average controllability score and/or encoding, and wherein the anomaly indicates presence or non-presence of an anomaly in the network system; and output an indication of an anomaly in the network system based on the output of the trained anomaly detector.

In some embodiments, instructions to generate the edge weight values for the set of edges, when executed, cause the processor to: adjust the set of generated average controllability score values using a scaling operator (e.g., to apply an offset or scale); and determine a weight value for each edge in the set of edges using a controllability score value of a node of the edge.

In some embodiments, instructions to generate the edge attributes for the set of edges, when executed, cause the processor to: generate a histogram object corresponding to a distribution of occurrence of specific average controllability score values determined across a set of steps for at least a change in state transition assessed using the Gramian operator; and determine an edge feature matrix for the set of edges by applying a rank encoding operator (e.g., one-hot encoding operator) based on if the average controllability of one or more source nodes resides in a corresponding edge.

In some embodiments, instructions to generate the set of controllability score values, when executed, cause the processor to: determine an adjacency matrix object of the graph; determine a largest absolute eigenvalue for the adjacency matrix object; generate a normalized adjacency matrix object using the largest absolute eigenvalue and an identity matrix object; and generate a controllability (e.g., Gramian) matrix object, wherein the controllability matrix object has diagonal entries forming the set of controllability score values.

In some embodiments, instructions to generate the trained anomaly detector, when executed, cause the processor to: receive a graph containing a set of nodes connected by a set of edges for a set of example network systems having labeled data associated with an anomaly (e.g., fraud, malware); generate a set of average controllability score values for the set of nodes, wherein each node of the set of nodes is assigned a generated average controllability score value, and wherein each average controllability score value defines control influence of a respective node in the graph based on a Gramian operator; generate one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node; assign the set of average controllability score values for the set of nodes and the one or more encodings for the set of edges to the graph to generate a modified graph; and apply (i) the modified graph as input to an anomaly detector including a graph neural network and (ii) the labeled data as training data to the anomaly detector.

### BRIEF DESCRIPTION OF DRAWINGS

FIGS. 1A-1C each shows an example system for detecting anomalies in a trained graph neural network model using average controllability metrics, in accordance with an illustrative embodiment.

FIGS. 2A-2B show an operation method for the exemplary system, in accordance with an illustrative embodiment.

FIG. 3A shows an example operation flow for the exemplary system, in accordance with an illustrative embodiment.

FIGS. 3B-3C show example algorithmic implementations for the exemplary system, in accordance with an illustrative embodiment.

FIGS. 4A-4C show performance evaluations of graph neural network (GNN) models when using and not using an experimental system and method described in FIGS. 1-3.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System

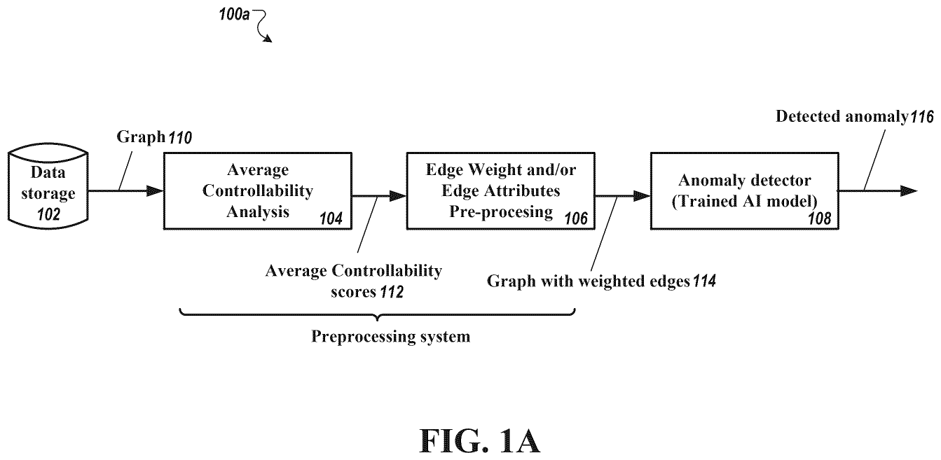

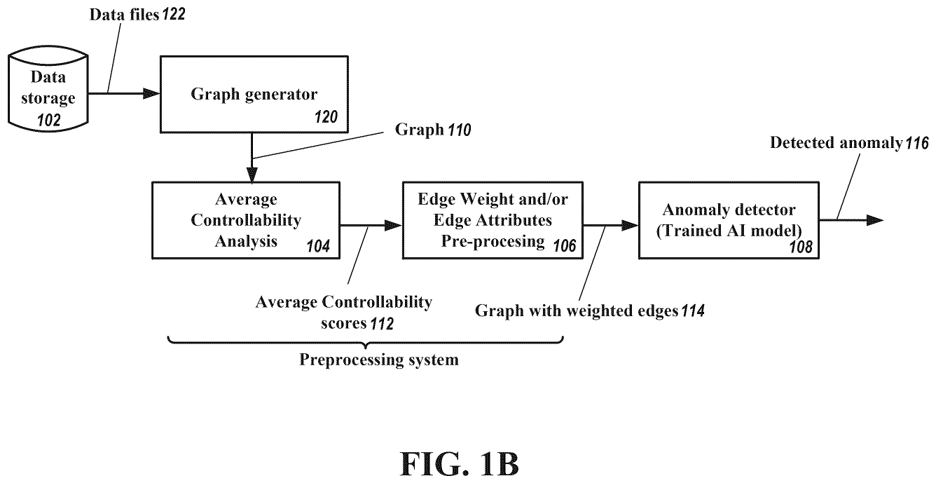

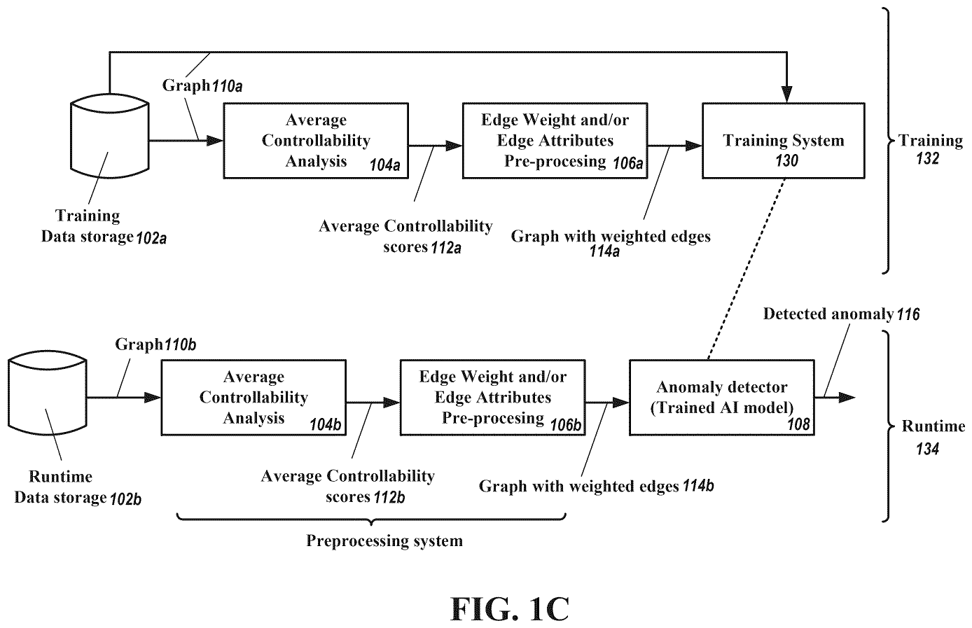

FIGS. 1A-1B each shows an example system configured with a data storage 102, an average controllability analysis module 104, an edge weight and/or edge attributes preprocessing module 106, and an anomaly detector 108 (e.g., trained artificial intelligence (AI) model). FIG. 1B employs a graph generator. FIG. 1C employs a training system 130 configured to train the anomaly detector 108 in a training stage 132.

In the example shown in FIGS. 1A and 1C, the average controllability analysis module 104 (also shown as 104b) receives a graph 110 (also shown as 110b) directly from the data storage 102 (also shown as 102b) (e.g., training data storage, runtime data storage). In the example shown in FIG. 1B, the average controllability analysis module 104 receives the graph 110 generated by the graph generator 120 using data files 122 for a network system from the data storage 102. The graph 110 contains a set of nodes connected by a set of edges defined by the network system.

The data or data files 122 for a network system may include bank account information in a banking network system, blockchain account in a blockchain network system, computing device in an Internet network system, computing device in a local area or wide area computer network system, vehicle in a transportation network system, and user account in a social network system.

In the examples shown in FIGS. 1A-1C, the average controllability analysis module 104 is configured to generate a set of average controllability score values 112 (also shown as 112b) for the set of nodes. To generate the set of average controllability score values 112, the average controllability analysis module 104 can (i) determine an adjacency matrix object of the graph 110, (ii) determine a largest absolute eigenvalue for the adjacency matrix object, (iii) generate a normalized adjacency matrix object using the largest absolute eigenvalue and an identity matrix object, and (iv) generate a controllability matrix object (e.g., Gramian operator), wherein the controllability matrix object has diagonal entries forming the set of controllability score values 112. The average controllability analysis module 104 then sends the set of controllability score values 112 to the edge weight and/or edge attributes preprocessing module 106.

In the examples shown in FIGS. 1A-1C, the edge weight and/or edge attributes preprocessing module 106 (also shown as 106b), after receiving the set of controllability score values 112 and the graph 110, can assign each node of the set of nodes (in the graph 110) a generated average controllability score value 112, wherein each average controllability score value 112 defines the control influence of a respective node in the graph 110 based on the Gramian operator. The preprocessing module 106 can generate one or more encodings for the set of edges using the set of average controllability score values 112 for the set of nodes, wherein the encoding includes at least one of (i) an edge weight value that corresponds to a distance from a node to a source node or (ii) an edge attribute that corresponds to a distribution of average controllability score for the node. The preprocessing module 106, in FIGS. 1A-1, and in a runtime stage 134 in FIG. 1C, can then apply the modified graph 114 (also shown as 114b) as input to the trained anomaly detector 108 comprising a graph neural network.

The preprocessing module 106 can generate the edge weight values for the set of edges by (i) adjusting the set of generated average controllability score values 112 using a scaling operator (e.g., to apply an offset or scale) and (ii) determining a weight value for each edge in the set of edges (in the graph 110) using a controllability score value 112 of a node of the edge. The preprocessing module 106 can assign the set of average controllability score values 112 for the set of nodes and the one or more encodings for the set of edges to the graph 110 to generate a modified graph 114 (e.g., a graph with weighted edges). The preprocessing module 106 can also generate the edge attribute values for the set of edges by (i) generating a histogram object corresponding to a distribution of occurrence of specific average controllability score value 112 determined across a set of steps for at least a change in state transition accessed using the Gramian operator, and (ii) determining an edge feature matrix for the set of edges by applying a rank encoding operator (e.g., one-hot encoding operator) based on if the average controllability of one or more source nodes resides in a corresponding edge. The edge attribute for each edge can be formed by applying one-hot encoding to a node (e.g., the source node) of the edge. The edge attribute can be evaluated bidirectionally in relation to the source node.

In the example shown in FIG. 1C, the training system 130, in the training stage 132, can receive (i) the modified graph 114a from the preprocessing module 106a and (ii) the original graph 110a directly from the training data storage 102a. The anomaly detector 108, after being trained by the training system 130 in the training stage 132, can detect anomalies 116 in the runtime stage 134 upon receiving the modified graph 114b as input from the preprocessing module 106b.

In the examples shown in FIGS. 1A-1C, the trained anomaly detector 108 is configured to detect an anomaly 116 based on at least one of the average controllability scores 112 and/or encodings, wherein the anomaly indicates the presence or non-presence of an anomaly in the network system. The trained anomaly detector 108 then outputs an indication of an anomaly in the network system based on its output.

### Example Method

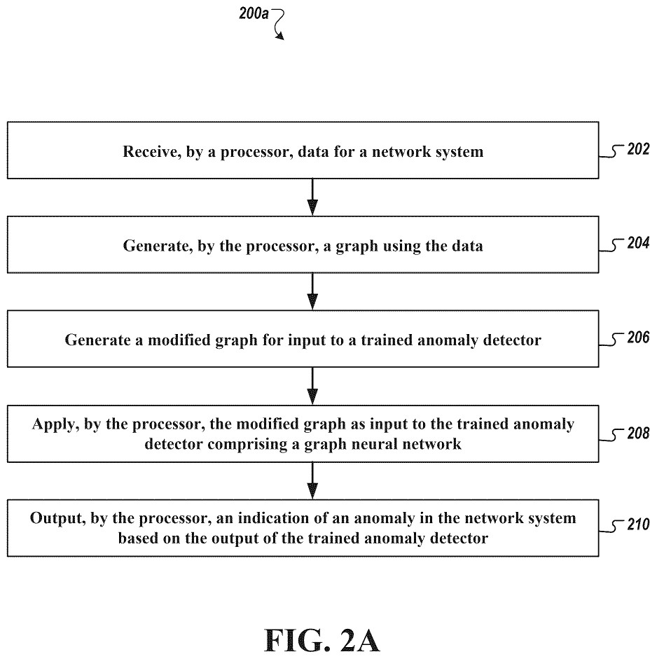

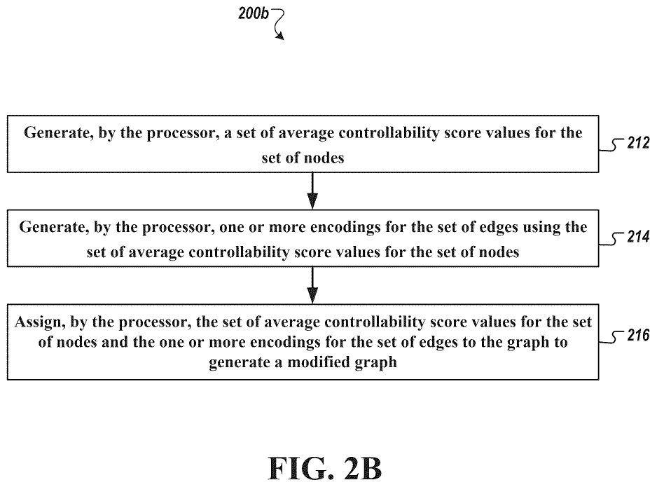

FIG. 2A shows an example operation method 200a for the exemplary system, in accordance with an illustrative embodiment. The method 200a includes receiving (202), by a processor, data (e.g., 122, FIG. 1B) for a network system. In some embodiments, the data for the network system includes bank account information in a banking network system, blockchain account in a blockchain network system, computing device in an Internet network system, computing device in a local area or wide area computer network system, vehicle in a transportation network system, and user account in a social network system.

The method 200a includes generating (204), by the processor, a graph (e.g., 110, FIGS. 1A-1C) using the data (e.g., 122, FIG. 1), where the graph (e.g., 110, FIGS. 1A-1C) contains a set of nodes connected by a set of edges as defined by the network system. The method 200a includes generating (206) a modified graph (e.g., 114, FIGS. 1A-1C) for input to a trained anomaly detector (e.g., 108, FIGS. 1A-1C). The method 200a includes applying (208), by the processor, the modified graph (e.g., 114, FIGS. 1A-1C) as input to the trained anomaly detector (e.g., 108, FIGS. 1A-1C) comprising a graph neural network. The method 200a includes outputting (210), by the processor, an indication of an anomaly in the network system based on the output of the trained anomaly detector (e.g., 108, FIGS. 1A-1C).

FIG. 2B shows an example method 200b (shown as 206 in FIG. 2A) for generating the modified graph (e.g., 114, FIGS. 1A-1C) for input to the trained anomaly detector (e.g., 108, FIGS. 1A-1C), in accordance with an illustrative embodiment. The method 200b includes generating (212), by the processor, a set of average controllability score values (e.g., 112, FIGS. 1A-1C) for the set of nodes. In some embodiments, each node of the set of nodes is assigned a generated average controllability score value (e.g., 112, FIGS. 1A-1C), and each average controllability score value defines a control influence of a respective node in the graph (e.g., 110, FIGS. 1A-1C) based on a Gramian operator.

The method 200b includes generating (214), by the processor, one or more encodings for the set of edges using the set of average controllability score values for the set of nodes. In some embodiments, the encoding includes at least one of (i) an edge weight value that corresponds to a distance from a node to a source node or (ii) an edge attribute that corresponds to a distribution of average controllability score for the node. The method 200b includes assigning (216), by the processor, the set of average controllability score values (e.g., 112, FIGS. 1A-1C) for the set of nodes and the one or more encodings for the set of edges to the graph (e.g., 110, FIGS. 1A-1C) to generate a modified graph (e.g., 114, FIGS. 1A-1C).

In some embodiments, the trained anomaly detector (e.g., 108, FIGS. 1A-1C) is configured to detect an anomaly (e.g., 116, FIGS. 1A-1C) based on at least one of average controllability score and/or encoding, and the anomaly (e.g., 116, FIGS. 1A-1C) indicates a presence or a non-presence of an anomaly in the network system.

In some embodiments, the edge weight values for the set of edges are generated by (i) adjusting, by the processor, the set of generated average controllability score values (e.g., 112, FIGS. 1A-1C) using a scaling operator (e.g., to apply an offset or scale), and (ii) determining, by the processor, a weight value for each edge in the set of edges using a controllability score value (e.g., 112, FIGS. 1A-1C) of a node of the edge.

In some embodiments, the edge attributes for the set of edges are generated by (i) generating, by the processor, a histogram object corresponding to a distribution of occurrence of specific average controllability score values determined across a set of steps for at least a change in state transition assessed using the Gramian operator, and (ii) determining, by the processor, an edge feature matrix for the set of edges by applying a rank encoding operator (e.g., one-hot encoding operator) based on if the average controllability of one or more source nodes resides in a corresponding edge. The edge attribute for each edge can be formed by applying one-hot encoding to a node (e.g., a source node) of the edge. The generated histogram object can have a plurality of bins, each bin having (i) a width representing a range of controllability values (e.g., 112, FIGS. 1A-1C), and (ii) a height representing a frequency of nodes whose controllability score value falls within said range.

In some embodiments, the generation (212) of the set of controllability score values (e.g., 112, FIGS. 1A-1C) includes (i) determining, by the processor, an adjacency matrix object of the graph (e.g., 110, FIGS. 1A-1C), (ii) determining, by the processor, a largest absolute eigenvalue for the adjacency matrix object, (iii) generating, by the processor, a normalized adjacency matrix object using the largest absolute eigenvalue and an identity matrix object, and (iv) generating, by the processor, a controllability (e.g., Gramian) matrix object, where diagonal entries of the controllability matrix object form the set of controllability score values.

In some embodiments, a generation of the trained anomaly detector (e.g., 108, FIGS. 1A-1C) includes (i) receiving, by the processor, a graph (e.g., 110, FIGS. 1A-1C) containing a set of nodes connected by a set of edges for a set of example network systems having labeled data associated with an anomaly (e.g., fraud, malware), (ii) generating, by the processor, a set of average controllability score values (e.g., 112, FIGS. 1A-1C) for the set of nodes, where each node of the set of nodes is assigned a generated average controllability score value, (iii) generating, by the processor, one or more encodings for the set of edges using the set of average controllability score values (e.g., 112, FIGS. 1A-1C) for the set of nodes, (iv) assigning, by the processor, the set of average controllability score values (e.g., 112, FIGS. 1A-1C) for the set of nodes and the one or more encodings for the set of edges to the graph (e.g., 110, FIGS. 1A-1C) to generate a modified graph (e.g., 114, FIGS. 1A-1C), and (v) applying, by the processor, the modified graph (e.g., 114, FIGS. 1A-1C) as input to the anomaly detector (e.g., 108, FIGS. 1A-1C) comprising a graph neural network and the labeled data as training data for the anomaly detector (e.g., 108, FIGS. 1A-1C).

### Example Graph Anomaly Detection (GAD) System

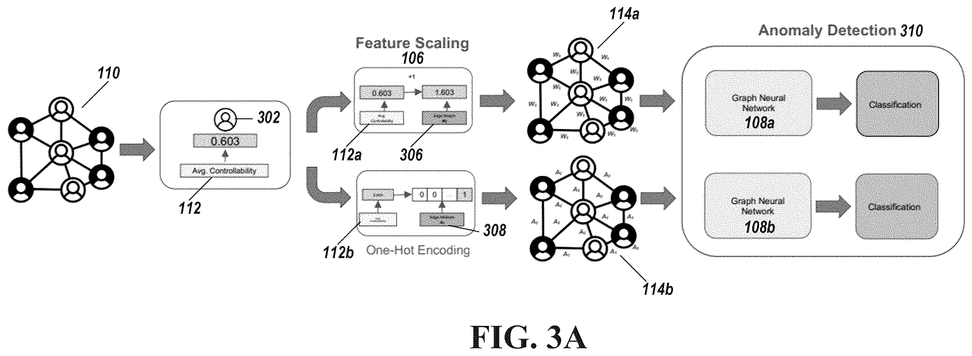

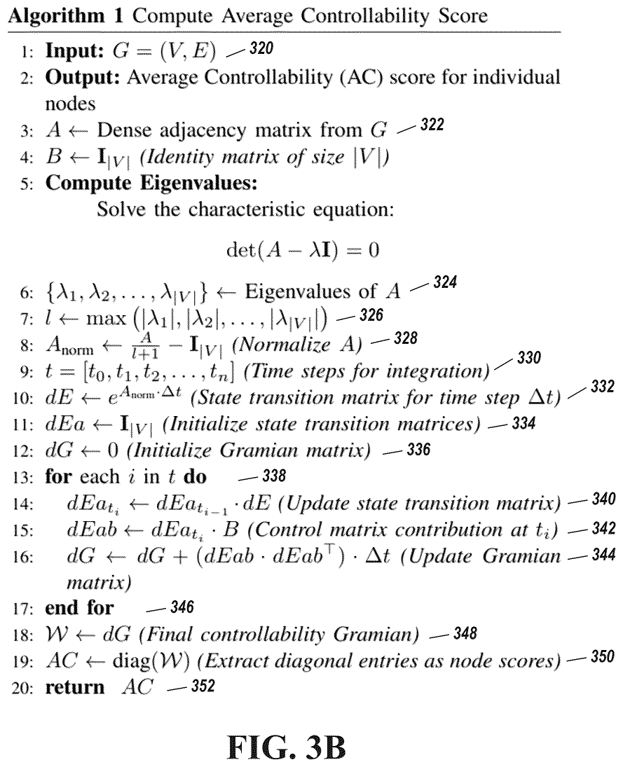

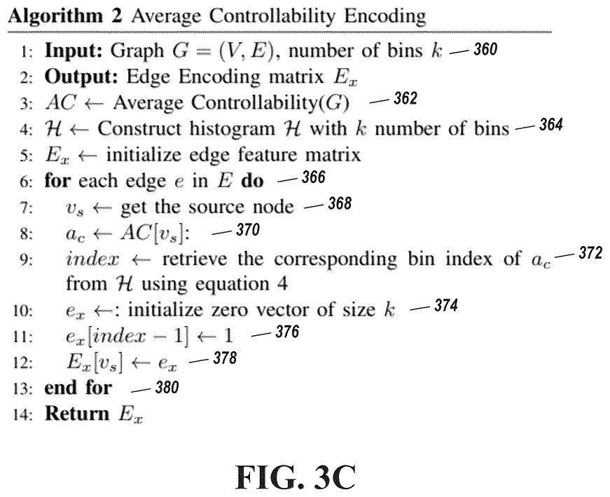

FIG. 3A shows an example operation flow of the exemplary system (also referred to as the GAD system), in accordance with an illustrative embodiment. As shown, the exemplary system is configured to (i) use network control theory (NCT) metrics (e.g., average controllability 112) to quantify the influence of each node 302 in a graph 110, (ii) generate a graph 114 (e.g., 114a, 114b) using parameters (e.g., edge weight 306, edge attribute 308) that are derived from feature scaling 106 based on the NCT metrics, and (iii) train a graph neural network (GNN) model 108 (e.g, 108a, 108b) on the generated graph 114 (e.g., 114a, 114b) for anomaly detection 310. In some embodiments, during feature scaling 106, the exemplary system derives a numerical average controllability value 112 (e.g., 112a, 112b) for each node of a graph 110 and converts the controllability value 112 (e.g., 112a, 112b) into graph features, such as edge weight 306 and edge attribute 308, which are passed in as an additional parameter into the GNN 108 (e.g., 108a, 108b) to perform binary node classification (e.g., benign nodes and anomalies).

Network Control Theory (NCT). By identifying control nodes within a graph (e.g., 110, FIGS. 1A-1C), similar to influential nodes in a network, NCT can refine graph representations to capture the structural characteristics of these nodes and their ability to influence overall graph behavior, including propagating information and reconfiguring relationships within the graph to achieve specific objectives [20].

The structural foundation of NCT can be defined by a network represented by an adjacency matrix A∈R^{N×N}, where N=|V| denotes the number of nodes, and a control set matrix B∈R^{N×m}. The temporal dynamics of each node, denoted as xᵢ(t), can be driven by a composite function that reflects the combined influence of all other nodes, xⱼ(t), along with external inputs u(t), modulated by weights in the network's topology. The evolution of node states can be described in terms of rates of change, where prior node activities impact the rate at which subsequent nodes' states evolve. This interaction can be modeled per Equation 1.

$$\frac{d}{dt} x ( t ) = Ax + Bu ( t ) \qquad ( Eq . 1 )$$

In Equation 1, x(t)=[x₁(t), x₂(t), . . . , xₙ(t)]^{T} is the vector of node states, A is the adjacency matrix, and u(t)=[u₁(t), u₂(t), . . . , uₙ(t)]^{T} is the vector of control signals. The matrix B ∈R^{N×m} quantifies the influence of the inputs on each node. In some embodiments, B∈R^{N×N} can be an identity matrix, indicating a fully controllable system.

A tool in network control is the controllability Gramian, which measures the ease with which the system can be driven from one state to another using control inputs. In the system defined by Equation 1, the infinite-horizon controllability Gramian can be defined by Equation 2.

$$W = {\int }_{0}^{∞} {e}^{- A τ} ( - B ) {( - B )}^{⊤} {e}^{- {A}^{⊤} τ} d τ ∈ {R}^{{N}_{f} \times {N}_{f}} \qquad ( Eq . 2 )$$

For a stable system, where all eigenvalues of −A have negative real parts, the Gramian W converges and can be derived from Equation 3 (e.g., the Lyapunov equation).

$$( - A ) W + {W ( - A )}^{⊤} + ( - B ) {( - B )}^{⊤} = 0 \qquad ( Eq . 3 )$$

The system described by Equation 1 may compute several NCT metrics, including the average controllability metric.

Average Controllability. Average controllability quantifies the power of individual nodes to influence a network [2]. Nodes with varying degrees of average controllability possess different abilities to impact the network (e.g., a graph). Therefore, converting the average controllability into graph-related features (e.g., edge attributes, edge weights, etc.) and transforming the graph data with additional topology information can improve the accuracy of graph anomaly detection.

FIG. 3B shows an example algorithmic implementation for the exemplary system to compute the average controllability score for each node in a graph (e.g., 110, FIGS. 1A-1C), which facilitates the generation of enhanced graph representations (e.g., 114, FIGS. 1A-1C) tailored for GNN-based anomaly detection.

In FIG. 3B, the exemplary system receives, at step 320, the input graph G=(V, E) (e.g., 110, FIGS. 1A-1C) and extracts, at step 322, a dense adjacency matrix A of the input graph G. At steps 324 and 326, the exemplary system computes the largest absolute eigenvalue l of the matrix A. At step 328, the exemplary system normalizes the matrix A by dividing it by l+1 and subtracting the identity matrix I. At step 330, the exemplary system defines a series of time steps t. At step 332, the exemplary system computes a matrix exponential e^{A}^{ₙₒᵣₘ}^{Δt} to model how the exemplary system evolves. At steps 334 and 336, the exemplary system initializes a state-transition matrix (denoted as dEa) and a controllability Gramian matrix (denoted as dG). At steps 338-346, the exemplary system iterates over each time step t, (i) updating the state transition matrix dEa by multiplying it by the control matrix (denoted as B), and (ii) computing the controllability Gramian matrix dG using the state transition matrix and the transpose of the state transition matrix. At steps 348-352, the exemplary system extracts the diagonal entries of the controllability Gramian matrix to obtain an average controllability score (denoted as AC) for each node.

Network Construction with Derived Parameters. The average controllability (e.g., 112, FIGS. 1A-1C) can be used to generate parameters for the GNN, such as edge weights and edge attributes. Edge weights can define the strength or importance of connections between nodes, while edge attributes provide additional information about those connections. Average controllability can influence both parameters (e.g., edge weights, edge attributes), so the exemplary system can embed the information about average controllability into both parameters.

Table 1 shows example implementations of edge weights and edge attributes in a graph.

TABLE 1

| Graph parameter | Implementation |
|---|---|
| Edge weights | GNNs can operate on undirected graphs, where connections between nodes are |
| | bidirectional. To maintain compatibility with this structure, the graph (e.g., 110, |
| | FIGS. 1A-1C) may be modified by adding reciprocal edges so that every |
| | connection is bidirectional. Additionally, the average controllability scores (e.g., |
| | 112, FIGS. 1A-1C) can be constrained to lie between 0 and 1, making it |
| | challenging to distinguish differences across nodes. To address this limitation, |
| | the differentiation can be enhanced by adding 1 to each average controllability |
| | score. Finally, weights can be assigned to the edges based on the average |
| | controllability of the source node, so edges originating from highly controllable |
| | nodes can receive greater weight. This weighting method can help GNNs |
| | prioritize connections critical to the network's overall controllability, thereby |
| | improving their sensitivity to anomalies that disrupt these crucial connections. |
| Edge attributes | The average controllability can be encoded into vector representations, e.g., |
| | edge attributes, to provide additional context for message passing. FIG. 3C |
| | shows an example algorithmic implementation for the exemplary system to |
| | encode average controllability into a graph (e.g., vector representation of a |
| | graph) as edge attributes. |
| | In FIG. 3C, at steps 360 and 362, the exemplary system receives an average |
| | controllability vector for all nodes in the input graph G = (V, E) (e.g., 110, FIGS. |
| | 1A-1C), which can be computed as described in FIG. 3B, where each entry |
| | corresponds to a node in the input graph. At step 364, the exemplary system |
| | generates a histogram H with k bins (e.g., with approach [3]) to capture the |
| | distribution of controllability values. The histogram H can span from the |
| | minimum to the maximum average controllability value, and its bins cover the |
| | entire range. Each bin can be equal-width and represent a range of average |
| | controllability values, and its height can indicate a frequency of nodes whose |
| | controllability falls within that range. The histogram H can summarize the |
| | distribution of controllability across nodes, emphasizing the prevalence of |
| | specific controllability levels. At steps 366-380, to generate a feature vector |
| | for each edge e (e.g., e = (vₛ, vₜ), vₛ is source node, vₜ is target node of e) using |
| | H, the exemplary system employs one-hot encoding based on the average |
| | controllability of the source node vₛ. The one-hot encoded feature vector for |
| | $edge e , at index i , denoted as {h}_{e}^{0} ( i ) , can be defined by Equation 4.$ |
| | ${h}_{e}^{0} = \{ \begin{matrix}1 , & if {C}_{a} ( {v}_{s} ) ∈ H ( i ) \\ 0 , & otherwise\end{matrix} \qquad ( Eq . 4 )$ |

Graph NeuralNetworks. Graph Neural Networks (GNNs) (e.g., 108, FIGS. 1A-1C) are a class of neural networks configured to operate on graph-structured data [4]. Unlike neural networks that process feature vectors, GNNs process node, edge, and graph-level information to extract patterns and make predictions. A mechanism that drives GNNs is message passing, in which nodes iteratively exchange information with their neighbors and aggregate the information to update their representations. By passing messages through the graph, GNNs can capture both the structural information of the graph and the features (e.g., edge weights, edge attributes) associated with each node.

The message-passing process at each layer l of the GNN can include two steps: message aggregation and node update. A form of message aggregation can be defined by

$${m}_{i}^{( l )} = {\sum }_{j ∈ N ( i )} M ( {h}_{i}^{( l )} , {h}_{j}^{( l )} , {e}_{ij} ) \qquad ( Eq . 5 )$$

In Equation 5,

$${m}_{i}^{( l )}$$

is a message for node i at layer l, N(i) is the set of neighboring nodes of node i,

$${h}_{i}^{( l )} and {h}_{j}^{( l )}$$

are the hidden states of the node i and its neighbor j at layer l, eᵢⱼ are edge features between nodes i and j, and M(⋅) is the message function.

After aggregating messages from its neighbors, a node's hidden state can be updated using Equation 6.

$${h}_{i}^{( l + 1 )} = U ( {h}_{i}^{( l )} , {m}_{i}^{( l )} ) \qquad ( Eq . 6 )$$

In Equation 6,

$${h}_{i}^{( l + 1 )}$$

is an updated hidden state of node i at layer l+1,

$${h}_{i}^{( l )}$$

is the current state of node i at layer l,

$${m}_{i}^{( l )}$$

is the aggregated message from neighboring nodes at layer l, and U(⋅) is the update function.

Incorporating edge weights, wᵢⱼ, as edge features can enhance the message passing process in GNNs. Edge edge weight wᵢⱼ modulates the influence of neighbor nodes on the central node. By incorporating edge weights, the message-passing process can become more fine-grained, allowing the GNNs to prioritize information from more influential neighbors. The modified message aggregation can be defined by Equation 7.

$${m}_{i}^{( l )} = {\sum }_{j ∈ N ( i )} {w}_{ij} \cdot M ( {h}_{i}^{( l )} , {h}_{j}^{( l )} ) \qquad ( Eq . 7 )$$

In Equation 7, edge weights wᵢⱼ scale the contribution of each neighbor j to node i's update, helping the GNNs aggregate edge information with importance.

Edge attributes eᵢⱼ can provide an additional measure to help the GNNs understand the relationship between nodes. Instead of treating all edges as homogeneous, edge attributes, such as one-hot encoded vectors, can facilitate GNNs to incorporate relationship-specific details, leading to more informative message passing.

### Example Artificial Intelligence (AI) and Machine Learning (ML) Models

Machine Learning. In addition to the machine learning features described above, the exemplary system can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include, but are not limited to, artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Experimental Results and Additional Examples

A study was conducted to develop and evaluate an experimental system and method for detecting anomalies in a graph (e.g., a network) using average controllability values of individual nodes, as described in relation to FIGS. 1-3.

### Experimental Preparation

Graph Neural Networks. To evaluate the effectiveness of incorporating edge weights and edge attributes into graph neural networks (GNNs), the study selected 10 graph neural network models compatible with these features. In the study, (i) 6 models, k-GCN, BGNN, SGC, GIN, GraphSAGE, and TAG, used edge weights in their forward pass, and (ii) 4 models, GEN, RES, GAT2, and UniMP, used edge attributes. Table 2 shows the configurations ofthe graph neural network models in the study.

TABLE 2

| | Model | Configuration |
|---|---|---|
| GNN | k-GCN | k-GCN used a localized, first-order approximation of spectral graph |
| models | | convolutions to aggregate features from neighboring nodes. This |
| with edge | | facilitated the k-GCN to encode both local graph structure and node |
| weights | | features into low-dimensional embeddings, which could be used for |
| | | tasks such as node classification and link prediction [4]. |
| | BGNN | BGNN combined GNNs with gradient-boosting decision trees |
| | | (GBDT), which preprocessed node features for both models to |
| | | iteratively enhance predictions [6]. |
| | SGC | SGC was a simplified GCN that reduced the complexity of graph |
| | | convolution by removing non-linearities and collapsing weight |
| | | matrices across layers [7]. |
| | GIN | GIN was a message-passing framework model configured to capture |
| | | graph isomorphism, enhancing feature aggregation through GINConv |
| | | [8]. |
| | GraphSAGE | GraphSAGE used inductive learning by sampling and aggregating |
| | | node features from local neighborhoods [5]. |
| | TAG | TAG employed fixed-size learnable filters for convolution, enhancing |
| | | efficiency through a localized approach [9]. |
| GNN | GEN | GEN introduced energy dynamics into graph convolution, |
| models | | emphasizing influential nodes and edges to highlight structural |
| with edge | | patterns for tasks like anomaly detection [10]. |
| attributes | ResGatedGraph | ResGatedGraph used residual connections to enable deeper networks |
| | | by retaining original node information, helping to mitigate the |
| | | vanishing gradient problem [11]. |
| | GATv2d | GATv2d enhanced attention mechanisms from the GAT, improving |
| | | the precision of neighbor selection and feature aggregation with |
| | | multiple attention heads [12]. |
| | UniMP | UniMP adapted the self-attention mechanism from sequence models |
| | | to graph data, allowing nodes to attend to all others in the graph, |
| | | facilitating the capture of long-range dependencies and global |
| | | interactions [13]. |

Dataset. The study used anomaly-detection datasets to evaluate various GNNs that employed the experimental method. Table 3 shows the anomaly-detection datasets used for the evaluation.

TABLE 3

| Dataset | Description |
|---|---|
| Real-world | The study used the Reddit dataset from the GAD Benchmark dataset [14], which |
| datasets | included 10,984 nodes, 3.3% of which were anomalies, and 168,016 edges. Each |
| | node was represented by 64 features, derived from text embeddings. Node |
| | relationships were defined by nodes that appear in the same post. |
| | The study also used the Amazon dataset from the GAD Benchmark dataset [14] |
| | and the FraudAmazon dataset from DGL [7]. The FraudAmazon dataset included |
| | product reviews under the Musical Instruments category. Users with more than |
| | 80% helpful votes were labeled as benign entities, while users with less than 20% |
| | helpful votes were labeled as fraudulent entities. The FraudAmazon dataset |
| | included 11,944 nodes and three different types of edge allocation: U-P-U, U-S- |
| | U, and U-V-U. Each node was described by 25 handcrafted features. |
| Synthetic | Due to the lack of datasets that define anomalies, the study modified a node |
| dataset | classification dataset, Cora [15], by injecting structural and contextual anomalies. |
| | For structural anomalies, the study first selected m × n nodes that could be |
| | grouped into structural anomaly clusters. These nodes were divided into n groups, |
| | each containing m nodes. Within each group, all possible pairs of nodes were |
| | considered for potential new edges. A new edge was added between a pair of |
| | nodes with a probability of 1 − p, provided the edge did not exist in the graph. |
| | This process altered the local connectivity of the graph, rendering these groups |
| | structurally anomalous. These selected nodes were labeled as anomalies with a |
| | value of 1 in the label tensor. |
| | For contextual anomalies, the study randomly selected m × n nodes (denoted as |
| | V_{c}) to serve as contextual anomalies. The remaining nodes were stored in Vᵣ. For |
| | each node in V_{c}, the study randomly selected q nodes from Vᵣ. Among the q |
| | nodes, the one with the most dissimilar feature vector (measured by Euclidean |
| | distance) was identified. The feature vector of the most dissimilar node was then |
| | copied to the corresponding node in V_{c}, making its features different from those |
| | of its neighboring nodes. The nodes in V_{c} were labeled with 1 in the label tensor, |
| | indicating that they were contextual anomalies. All other nodes in the dataset |
| | were considered normal. |

Evaluation Metrics. The study selected the Area Under the Receiver Operating Characteristic Curve (AUROC), the Area Under the Precision-Recall Curve (AUPRC) calculated by average precision, and the Recall score within top-k predictions (Rec@K) as performance metrics for the GAD task [14]. The study set K as the number of anomalies within the test set.

For all metrics, anomalies were considered as the positive class, and higher scores indicated better model performance. Among the metrics, AUROC focused on overall performance and was not sensitive to top-k predictions, Rec@K focused on top-K performance, and AUPRC struck a balance between the two. For example, if the test set included 10 anomalies within 1000 data points and a model ranked them from positions 11^{th} to 20^{th}, the model would achieve an AUROC of 0.99, an AUPRC of 0.33, and a Rec@10 of 0.

The study selected Recall at K (Rec@K) over Recall because the prediction order was critical in GAD. In practical applications, priority was given to the top-ranked results as potential anomalies. Therefore, by evaluating the proportion of true anomalies within the top-K predictions, Rec@K provided a more accurate measure of a GNN model's ability to identify anomalies. The Rec@K metric measured how well the GNN model prioritized the most relevant anomalous nodes, which could be crucial in scenarios where only the most suspicious cases warranted further investigation.

Parameters Setup. The study utilized a step size of 0.2 and treated the experimental system as continuous to calculate the average controllability. Each GNN model was configured with two layers of a corresponding graph convolutional network (GCN) and a multilayer perceptron (MLP) for classification. Specifically, the first GCN layer transformed the original node features into a 32-dimensional space, while the second GCN layer maintained the feature dimensions at 32. The MLP layer performed the final binary classification. The study applied the rectified linear unit (ReLU) activation function throughout the network and set the dropout rate to 0.

For GNN models that incorporated edge attributes, the study encoded the attributes using a fully connected linear layer within the GNN context. The number of epochs for each trial was set to 200, and the learning rate was fixed at 0.01. To address class imbalance, the study used a weighted cross-entropy loss function, where the weight was defined as the ratio of benign nodes to anomalous nodes. The study employed the Adam optimizer for model optimization. In the experiments involving edge attributes, bin sizes were configured as a hyperparameter, and each dataset was evaluated with bin sizes of 5, 20, 30, and 50. The study ran each experiment 10 times with 10 different seeds and reported the average scores.

Results for GNNs with Edge Weights

The study evaluated 6 GNN models (e.g., GCN, BGNN, SGC, GIN, GraphSAGE, and TAG) for GAD by comparing their performance with and without the edge weights using AUROC, AUPRC, and Rec@K metrics on the Reddit dataset. The study trained each GNN model with the same hyperparameters, then used the experimental method to integrate the metrics and train the same model on the augmented data.

Table 4 shows the performance results of neural network models (e.g., GCN, BGNN, SGC, GIN, GraphSAGE, TAG) with and without edge weights (EW) as parameters in the forward pass.

TABLE 4

| | GCN | | BGNN | | SGC | | GIN | | GraphSAGE | | TAG | |
|---|---|---|---|---|---|---|---|---|---|---|---|---|
| | | No | | No | | No | | No | | No | | No |
| Metrics | EW | EW | EW | EW | EW | EW | EW | EW | EW | EW | EW | EW |
| AUROC | 0.615 | 0.613 | 0.687 | 0.682 | 0.553 | 0.553 | 0.596 | 0.649 | 0.646 | 0.649 | 0.646 | 0.615 |
| AUPRC | 0.050 | 0.046 | 0.067 | 0.066 | 0.047 | 0.047 | 0.060 | 0.061 | 0.059 | 0.057 | 0.059 | 0.047 |
| Rec@K | 0.068 | 0.061 | 0.068 | 0.054 | 0.082 | 0.082 | 0.109 | 0.075 | 0.088 | 0.061 | 0.088 | 0.054 |

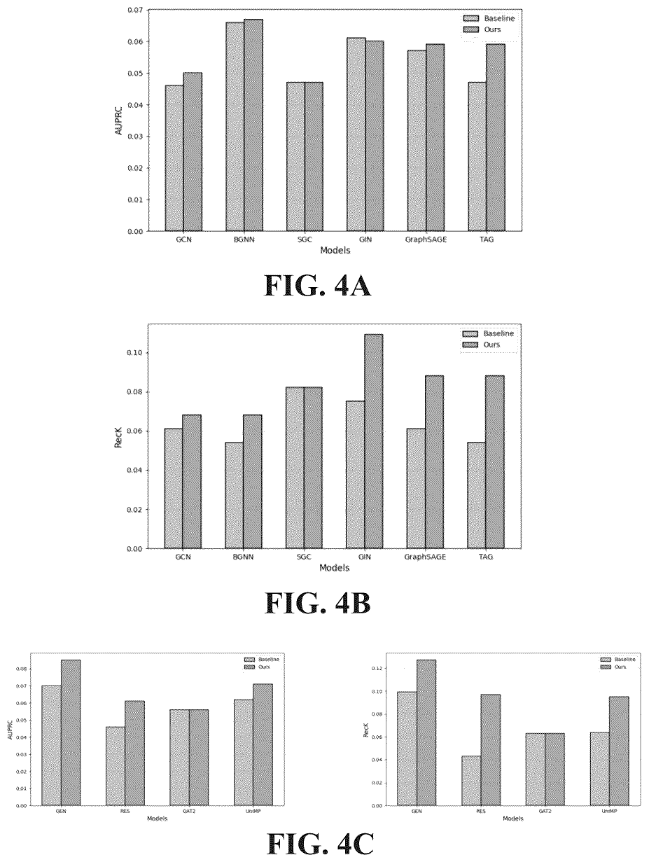

AUPRC Comparison. The AUPRC metric, which balanced precision and recall, was a better measure of the performance in the imbalanced Reddit dataset. FIG. 4A shows the AUPRC scores achieved by each GNN model, GCN, BGNN, SGC, GIN, GraphSAGE, and TAG, on the Reddit dataset.

In Table 4 and FIG. 4A, AUPRC improved performance across all GNN models with edge weights. BGNN's AUPRC score increased from 0.065 to 0.067, indicating a balanced recognition of positive cases. Graph-SAGE maintained a similar AUPRC score with and without edge weights (0.059 and 0.057), highlighting the model's consistent predictive performance in balancing precision and recall across configurations. SGC and GIN models exhibited similar trends, reflecting the overall stability of the models' performance.

Rec@K Comparison. FIG. 4B shows the Rec@K scores achieved by each GNN model, GCN, BGNN, SGC, GIN, GraphSAGE, and TAG, on the Reddit dataset.

In Table 4 and FIG. 4B, the Rec@K metric, which evaluated how well models prioritize true anomalies in the top-K predictions, showed a consistent increase across all models when edge weights were included. GCN's Rec@K showed a 10.5% increase. TAG's Rec@K showed a 62.4% increase, from 0.054 to 0.088, underscoring TAG's enhanced ability to prioritize true anomalies. Additionally, GraphSAGE's Rec@K showed a 44.4% increase, from 0.061 to 0.088, and GIN's Rec@K showed a 45.5% increase. The consistent increase across models highlighted the role of edge weights in improving top-K ranking performance.

Results for GNNs with Edge Attributes

The study evaluated 4 GNN models (e.g., GEN, RES, GAT2, UniMP) for GAD by comparing their performance with and without edge attributes using AUPRC and Rec@K metrics on the Reddit, FraudAmazon, and Injected Cora datasets. To construct the edge attributes, the study selected the configuration with the optimal overall performance among those with bin sizes of 10, 20, 30, and 50. The study focused on analyzing AUPRC and Rec@K metrics for the 4 GNN models because, first, each dataset was imbalanced, and second, the anomaly detection algorithm had a high probability of identifying true anomalies.

FIG. 4C shows the AUPRC and Rec@K scores achieved by each GNN model, GEN, RES, GAT2, and UniMP, on the Reddit dataset. Table 5 shows the performance results of the neural network models (e.g., GEN, RES, GAT2, UniMP) with and without edge attributes (EA) as an additional parameter in the forward pass.

TABLE 5

| | GEN | | RES | | GAT2 | | UniMP | |
|---|---|---|---|---|---|---|---|---|
| Metrics | EA | No EA | EA | No EA | EA | No EA | EA | No EA |

Reddit dataset

| | | | | | | | | |
|---|---|---|---|---|---|---|---|---|
| AUPRC | 0.085 | 0.070 | 0.061 | 0.046 | 0.056 | 0.056 | 0.071 | 0.062 |
| Reck@K | 0.127 | 0.099 | 0.097 | 0.043 | 0.063 | 0.063 | 0.095 | 0.064 |

Injected Cora dataset

| | | | | | | | | |
|---|---|---|---|---|---|---|---|---|
| AUPRC | 0.280 | 0.223 | 0.500 | 0.387 | 0.248 | 0.248 | 0.350 | 0.198 |
| Reck@K | 0.310 | 0.303 | 0.483 | 0.386 | 0.441 | 0.441 | 0.455 | 0.324 |

FraudAmazon dataset

| | | | | | | | | |
|---|---|---|---|---|---|---|---|---|
| AUPRC | 0.873 | 0.876 | 0.278 | 0.235 | 0.384 | 0.384 | 0.846 | 0.844 |
| Reck@K | 0.834 | 0.839 | 0.345 | 0.281 | 0.411 | 0.411 | 0.803 | 0.803 |

AUPRC Comparison. In Table 5, on the Reddit and Injected Cora datasets, the AUPRC scores of GEN, RES, and UniMP models increased when edge attributes were included, while the AUPRC score of GAT2 remained unchanged. The baseline for the AUPRC score was determined by the fraction of positives, which corresponded to the percentage of anomalies in the dataset. For example, the Reddit dataset contained 3.3% anomalies, setting the AUPRC baseline at 0.033. Although all GNN models exceeded the AUPRC baseline without edge attributes, including edge attributes still improved their performance (e.g., AUPRC scores). Specifically, edge attributes improved the AUPRC score of GEN by 20.7%, of RES by 32.9%, and of UniMP by 14.6%.

In the Injected Cora dataset, in which 50 contextual and 50 structural anomalies were injected, the baseline was 3.7% (0.037). In Table 5, each GNN model exceeded the AUPRC baseline, indicating that artificially injected anomalies were easy to detect. The addition of edge attributes further enhanced performance, with improvements in AUPRC scores of 25.2% for GEN, 29.3% for RES, and 76.6% for UniMP. Conversely, the study did not observe any improvements in AUPRC scores on the FraudAmazon dataset, suggesting that graph topology information was not crucial for anomaly detection in this dataset.

Rec@K Comparison. Recall@K (Rec@K) measured the models' ability to recommend true anomalies. In Table 5, all 4 GNN models, except for GAT2, showed an increase in successful anomaly detections on the Reddit and Injected Cora datasets. On the Reddit dataset, the successful anomaly detections increased from 9.9% to 12.6% for GEN, 4% to 10% for RES, and 6.4% to 9.5% for UniMP. Similarly, on the Injected Cora dataset, successful anomaly detections increased from 30% to 31% for GEN, from 38% to 48% for RES, and from 32% to 46% for UniMP. The study did not observe any improvements in the Rec@K scores on the FraudAmazon dataset, except for the RES model's Rec@K scores with an increase from 28% to 34%.

### DISCUSSION

Discussion #1. Network control theory (NCT) provides a mathematical framework for understanding how to influence the behavior of dynamic systems [1]. Within the NCT, average controllability measures how the state of an entire network can be steered from one initial state to any desired final state by applying control to specific target nodes [2]. Average controllability goes a step further by quantifying the ability of individual nodes to control the dynamics of the entire network, offering a unique perspective on their influence and importance. By calculating the average controllability for each node, the study can determine which nodes play critical roles in guiding the network's behavior. Nodes with higher average controllability have a greater capacity to influence the overall dynamics, making them more pivotal within the network structure [3]. This metric not only highlights the functional significance of individual nodes but also sheds light on the graph's underlying topology. Understanding the controllability provides valuable insights, particularly in applications such as graph anomaly detection, where the behavior of influential nodes can help identify irregularities and patterns that may go unnoticed by state-of-the-art methods.

Graph anomaly detection (GAD) is a vital area of study within network analysis, focusing on identifying unusual patterns or outliers in graph-structured data. These anomalies can manifest as irregularities in the structure or attributes of nodes and edges, which may indicate significant, often hidden, events such as fraud, network intrusions, or irregular user behavior. State-of-the-art methods for anomaly detection struggle to capture the complexity and the topology of the graph, making it challenging to model relationships and interactions accurately.

Graph Neural Networks (GNNs) have emerged as tools in this context, using the graph structure to enhance detection capabilities by learning both the local and global patterns inherent in the data [4]. GNNs use both the node attributes and the relational information between nodes, allowing them to capture complex dependencies that go beyond individual features. By integrating node features with their neighbors' information, GNNs can aggregate and update node representations through layers of message passing. This aggregation scheme, often involving functions like mean, sum, or max pooling, ensures that each node's final representation reflects not only its own characteristics but also the structure of its surrounding neighborhood [5].

Despite their strengths, GNNs also face limitations. The message-passing mechanisms, whether using attention-based models or standard aggregation techniques, often fail to capture the unique behaviors of anomalous nodes. Anomalous nodes may exhibit patterns that deviate from their neighbors, and state-of-the-art aggregation schemes tend to smooth out these distinct features by focusing on the average characteristics of the neighborhood [25]. As a result, these models may overlook or misrepresent critical anomalies.

To address this limitation, incorporating principles from control theory, specifically average controllability, can provide a more robust approach. Average controllability helps determine the importance of each node in terms of its ability to control or affect the behavior of the system [1], [2]. By integrating this measure, the study can better identify nodes that have disproportionate control or influence and incorporate that influence into the message passing, which could serve as indicators of anomalous behavior in complex networks.

The study developed an exemplary system and method to encode average controllability in two distinct ways and integrate controllability with GNNs. First, the study represented controllability as an edge weight through direct weight assignment, reflecting the control influence of each connection. Second, the study encoded controllability as an edge attribute using rank encoding, which may capture the relative importance of edges in terms of their ability to control the system in an attributed form. The study also conducted extensive experiments with six benchmark GNNs and three anomaly detection datasets.

Discussion #2. The study provided a comprehensive evaluation of graph neural networks (GNNs) for anomaly detection, focusing on the impact of incorporating edge attributes and edge weights into the models. The evaluation, conducted across various datasets, showed improvements in performance metrics, particularly AUPRC and Rec@K, when edge attributes or edge weights were included.

The results demonstrated that edge attributes enhanced model performance on datasets such as Reddit and Injected Cora, yielding substantial gains in both AUPRC and Rec@K scores. For instance, models such as GEN, RES, and UniMP benefited from increased precision and recall, as well as improved anomaly prioritization in the top-K detections. However, some datasets, such as FraudAmazon, showed limited improvement, suggesting that graph topology information may not be as crucial for anomaly detection in specific contexts.

Across all models and metrics, the inclusion of edge weights improved the models' ability to balance precision and recall, as evidenced by gains in AUPRC, and to effectively recommend true anomalies, as reflected by improvements in Rec@K. Models such as TAG, GraphSAGE, and GCN exhibited increased ability to prioritize anomalies, underscoring the critical role of edge attributes in enhancing GNN performance.

A future study can investigate why the inclusion of edge attributes improves the predictive ability of GCNs on some datasets but does not on others. A hypothesis is that, since the edge attribute serves as an additional tool to amplify the structural information of the graph, it may be beneficial only if the structural information is crucial for distinguishing anomalies from normal nodes. The future study may determine whether edge attributes can enhance performance from the initial graph data. The instant study compared the performance of an MLP, which classified nodes based on their features, with that of a GCN to assess whether the graph structure was useful. For example, in the FraudAmazon dataset, the MLP outperformed the GCN, suggesting that the graph structure did not play a role in node classification, which explained why edge attributes did not improve performance.

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with programming techniques with rule-based logic and other logic to accomplish the various connection steps, processing steps, comparison steps, and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1]A. Y. Yazicioglu, W. Abbas, and M. Egerstedt, “A tight lower bound on the controllability of networks with multiple leaders,” in *Proc. 2012 IEEE 51st Conf Decision Control*, pp. 1978-1983, 2012.
[2]L. Parkes, J. Z. Kim, J. Stiso, J. K. Brynildsen, M. Cieslak, S. Covitz, R. E. Gur, R. C. Gur, F. Pasqualetti, R. T. Shinohara, “A network control theory pipeline for studying the dynamics of the structural connectome,” *Nature Protocols*, pp. 1-29, 2024.
[3]A. Said, O. U. Ahmad, W. Abbas, M. Shabbir, X. Koutsoukos, “Improving graph machine learning performance through feature augmentation based on network control theory,” *arXiv preprint arXiv:2405.03706*, 2024.
[4]T. N. Kipf, M. Welling, “Semi-supervised classification with graph convolutional networks,” *arXiv preprint arXiv:1609.02907*, 2016.
[5]W. Hamilton, Z. Ying, and J. Leskovec, ‘Inductive representation learning on large graphs,’ Advances in Neural Information Processing Systems, vol. 30, 2017.
[6]S. Ivanov and L. Prokhorenkova, ‘Boost then convolve: Gradient boosting meets graph neural networks,’ 2021. [Online]. Available: https://arxiv.org/abs/2101.08543.
[7]F. Wu, T. Zhang, A. H. de Souza Jr., C. Fifty, T. Yu, and K. Q. Weinberger, ‘Simplifying graph convolutional networks,’ 2019. [Online]. Available:
https://arxiv.org/abs/i902.07153.
[8] Keyulu Xu, Weihua Hu, Jure Leskovec, Stefanie Jegelka, “How Powerful are Graph Neural Networks?,” arXiv preprint arXiv:1810.00826, 2019. [Online]. Available:
https://arxiv.org/abs/i810.00826
[9] Jian Du, Shanghang Zhang, Guanhang Wu, Jose M. F. Moura, Soummya Kar, “Topology Adaptive Graph Convolutional Networks,” arXiv preprint arXiv:1710.10370, 2018. [Online]. Available: https://arxiv.org/abs/1710.10370
[10]G. Li, C. Xiong, A. Thabet, and B. Ghanem, ‘Deepergcn: All you need to train deeper gcns,’ 2020. [Online]. Available: https://arxiv.org/abs/2006.07739.
[11]X. Bresson and T. Laurent, ‘Residual gated graph convnets,’ 2018. [Online]. Available: https://arxiv.org/abs/1711.07553.
[12]S. Brody, U. Alon, and E. Yahav, ‘How attentive are graph attention networks?,’ 2022. [Online]. Available: https://arxiv.org/abs/2105.14491.
[13]Y. Shi, Z. Huang, S. Feng, H. Zhong, W. Wang, and Y. Sun, ‘Masked label prediction: Unified message passing model for semi-supervised classification,’ 2021. [Online]. Available: https://arxiv.org/abs/2009.03509.
[14]J. Tang, F. Hua, Z. Gao, P. Zhao, and J. Li, “Gadbench: Revisiting and benchmarking supervised graph anomaly detection,” arXiv preprint arXiv:2306.12251, 2023. [Online]. Available: https://arxiv.org/abs/2306.12251.
[15]M. Wang, D. Zheng, Z. Ye, Q. Gan, M. Li, X. Song, J. Zhou, C. Ma, L. Yu, Y. Gai, T. Xiao, T. He, G. Karypis, J. Li, and Z. Zhang, “Deep graph library: A graph-centric, highly-performant package for graph neural networks,” arXiv preprint arXiv:1909.01315, 2019.
[16] Xiaoxiao Ma, Jia Wu, Shan Xue, Jian Yang, Chuan Zhou, Quan Z Sheng, Hui Xiong, Leman Akoglu, “A comprehensive survey on graph anomaly detection with deep learning,” IEEE Transactions on Knowledge and Data Engineering, vol. 35, no. 12, pp. 12012-12038, 2021.
[17] Thomas N Kipf, Max Welling, “Semi-supervised classification with graph convolutional networks,” arXiv preprint arXiv:1609.02907, 2016.
[18] Will Hamilton, Zhitao Ying, Jure Leskovec, “Inductive representation learning on large graphs,” Advances in Neural Information Processing Systems, vol. 30, 2017.
[19]A. Yasin Yazicioglu, Waseem Abbas, Magnus Egerstedt, “A tight lower bound on the controllability of networks with multiple leaders,” in *Proceedings of the IEEE 51st Conference on Decision and Control (CDC)*, pp. 1978-1983, 2012.
[20]A. Said, O. U. Ahmad, W. Abbas, M. Shabbir and X. Koutsoukos, “Network Controllability Perspectives on Graph Representation,” in IEEE Transactions on Knowledge and Data Engineering, vol. 36, no. 8, pp. 4116-4128, August 2024, doi: 10.1109/TKDE.2023.3331318.
[21] Ding Q, Katenka N, Barford P, Kolaczyk E D, Crovella M (2012) Intrusion as (anti)social communication: characterization and detection. In: Proceedings of the 18th ACM international conference on knowledge discovery and data mining (SIGKDD), Beijing, China. ACM, pp 886-894
[22] Bolton R J, Hand D J (2001) Unsupervised profiling methods for fraud detection. In: Proceedings of conference credit scoring and credit control VII, pp 5-7
[23] Parkes L, Moore T M, Calkins M E, Cieslak M, Roalf D R, Wolf D H, Gur R C, Gur R E, Satterthwaite T D, Bassett D S. Network Controllability in Transmodal Cortex Predicts Positive Psychosis Spectrum Symptoms. Biol Psychiatry. 2021 Sep. 15; 90(6):409-418. doi: 10.1016/j.biopsych.2021.03.016. Epub 2021 Mar. 21. PMID: 34099190; PMCID: PMC8842484.
[24]H. Kim, B. S. Lee, W.-Y. Shin and S. Lim, “Graph Anomaly Detection With Graph Neural Networks: Current Status and Challenges,” in IEEE Access, vol. 10, pp. 111820-111829, 2022, doi: 10.1109/ACCESS.2022.3211306
[25] Li, Q., Han, Z., & Wu, X. (2018). “Deeper Insights into Graph Convolutional Networks for Semi-Supervised Learning.” AAAI Conference on Artificial Intelligence.
[26] Gilmer, J., Schoenholz, S. S., Riley, P. F., Vinyals, O. Dahl, G. E. (2017). “Neural Message Passing for Quantum Chemistry.” Proceedings of the 34th International Conference on Machine Learning.
[27] Kim, Junghoon, et al. “Class Label-aware Graph Anomaly Detection.” Proceedings of the 32nd ACM International Conference on Information and Knowledge Management. 2023.
[28] Roy, Amit, et al. “Gad-nr: Graph anomaly detection via neighborhood reconstruction.” Proceedings of the 17th ACM International Conference on Web Search and Data Mining. 2024.
[29] He, Junwei, et al. “ADA-GAD: Anomaly-Denoised Autoencoders for Graph Anomaly Detection.” Proceedings of the AAAI Conference on Artificial Intelligence. Vol. 38. No. 8. 2024.
[30] Niu, Chaoxi, Guansong Pang, and Ling Chen. “Graph-level anomaly detection via hierarchical memory networks.” Joint European Conference on Machine Learning and Knowledge Discovery in Databases. Cham: Springer Nature Switzerland, 2023.
[31] Lin, Fu, et al. “Multi-representations Space Separation based Graphlevel Anomaly-aware Detection.” Proceedings of the 35th International Conference on Scientific and Statistical Database Management. 2023.
[32] Pan, Junjun, et al. “PREM: A Simple Yet Effective Approach for NodeLevel Graph Anomaly Detection.” 2023 IEEE International Conference on Data Mining (ICDM). IEEE, 2023.

What is claimed:

1. A method comprising:
receiving, by a processor, data for a network system;
generating, by the processor, a graph using the data, wherein the graph contains a set of nodes connected by a set of edges as defined by the network system;
generating a modified graph for input to a trained anomaly detector by:
generating, by the processor, a set of average controllability score values for the set of nodes, wherein each node of the set of nodes is assigned a generated average controllability score value, and wherein each average controllability score value defines control influence of a respective node in the graph based on a Gramian operator;
generating, by the processor, one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node; and
assigning, by the processor, the set of average controllability score values for the set of nodes and the one or more encodings for the set of edges to the graph to generate a modified graph;
applying, by the processor, the modified graph as input to the trained anomaly detector comprising a graph neural network, wherein the trained anomaly detector is configured to detect an anomaly based on at least one of average controllability score and/or encoding, and wherein the anomaly indicates presence or non-presence of an anomaly in the network system; and
outputting, by the processor, an indication of an anomaly in the network system based on the output of the trained anomaly detector.

2. The method of claim 1, wherein the edge weight values for the set of edges are generated by:
adjusting, by the processor, the set of generated average controllability score values using a scaling operator; and
determining, by the processor, a weight value for each edge in the set of edges using a controllability score value of a node of the edge.

3. The method of claim 1, wherein the edge attributes for the set of edges are generated by:
generating, by the processor, a histogram object corresponding to a distribution of occurrence of specific average controllability score values determined across a set of steps for at least a change in state transition assessed using the Gramian operator; and
determining, by the processor, an edge feature matrix for the set of edges by applying a rank encoding operator based on if the average controllability of one or more source nodes resides in a corresponding edge.

4. The method of claim 3, wherein the histogram object has a plurality of bins, wherein each bin has:
(i) a width representing a range of controllability values, and
(ii) a height representing a frequency of nodes whose controllability score value falls within said range.

5. The method of claim 3, wherein the edge attribute for each edge is formed by applying one-hot encoding to a node of the edge.

6. The method of claim 1, wherein the generation of the set of controllability score values comprises:
determining, by the processor, an adjacency matrix object of the graph;
determining, by the processor, a largest absolute eigenvalue for the adjacency matrix object;
generating, by the processor, a normalized adjacency matrix object using the largest absolute eigenvalue and an identity matrix object; and
generating, by the processor, a controllability matrix object, wherein the controllability matrix object has diagonal entries forming the set of controllability score values.

7. The method of claim 1, wherein the data for a network system including bank account information in a banking network system, blockchain account in a blockchain network system, computing device in an Internet network system, computing device in a local area or wide area computer network system, vehicle in a transportation network system, and user account in a social network system.

9. The method of claim 1, wherein a generation of the trained anomaly detector comprises:
receiving, by the processor, a graph containing a set of nodes connected by a set of edges for a set of example network systems having labeled data associated with an anomaly;
generating, by the processor, a set of average controllability score values for the set of nodes, wherein each node of the set of nodes is assigned a generated average controllability score value, and wherein each average controllability score value defines control influence of a respective node in the graph based on a Gramian operator;
generating, by the processor, one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node;
assigning, by the processor, the set of average controllability score values for the set of nodes and the one or more encodings for the set of edges to the graph to generate a modified graph; and
applying, by the processor, (i) the modified graph as input to an anomaly detector comprising a graph neural network and (ii) the labeled data as training data to the anomaly detector.

9. The method of claim 3, wherein the edge attribute is evaluated bidirectionally in relation to the source node.

10. A system comprising:
a processor; and
a memory having instructions stored thereon, wherein execution of the instructions causes the processor to:
receive data for a network system;
generate a graph using the data, wherein the graph contains a set of nodes connected by a set of edges as defined by the network system;
generate a modified graph for input to a trained anomaly detector by:
generating a set of average controllability score values for the set of nodes, wherein each node of the set of nodes is assigned a generated average controllability score value, and wherein each average controllability score value defines control influence of a respective node in the graph based on a Gramian operator;
generating one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node; and
assigning the set of average controllability score values for the set of nodes and the one or more encodings for the set of edges to the graph to generate a modified graph;
apply the modified graph as input to the trained anomaly detector comprising a graph neural network, wherein the trained anomaly detector is configured to detect an anomaly based on at least one of average controllability score and/or encoding, and wherein the anomaly indicates presence or non-presence of an anomaly in the network system; and
output an indication of an anomaly in the network system based on the output of the trained anomaly detector.

11. The system of claim 10, wherein instructions to generate the edge weight values for the set of edges, when executed, cause the processor to:
adjust the set of generated average controllability score values using a scaling operator; and
determine a weight value for each edge in the set of edges using a controllability score value of a node of the edge.

12. The system of claim 10, wherein instructions to generate the edge attributes for the set of edges, when executed, cause the processor to:
generate a histogram object corresponding to a distribution of occurrence of specific average controllability score values determined across a set of steps for at least a change in state transition assessed using the Gramian operator; and
determine an edge feature matrix for the set of edges by applying a rank encoding operator based on if the average controllability of one or more source nodes resides in a corresponding edge.

13. The system of claim 12, wherein the edge attribute for each edge is formed by applying one-hot encoding to a node of the edge.

14. The system of claim 10, wherein instructions to generate the set of controllability score values, when executed, cause the processor to:
determine an adjacency matrix object of the graph;
determine a largest absolute eigenvalue for the adjacency matrix object;
generate a normalized adjacency matrix object using the largest absolute eigenvalue and an identity matrix object; and
generate a controllability matrix object, wherein the controllability matrix object has diagonal entries forming the set of controllability score values.

15. The system of claim 10, wherein instructions to generate the trained anomaly detector, when executed, cause the processor to:
receive a graph containing a set of nodes connected by a set of edges for a set of example network systems having labeled data associated with an anomaly;
generate a set of average controllability score values for the set of nodes, wherein each node of the set of nodes is assigned a generated average controllability score value, and wherein each average controllability score value defines control influence of a respective node in the graph based on a Gramian operator;
generate one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node;
assign the set of average controllability score values for the set of nodes and the one or more encodings for the set of edges to the graph to generate a modified graph; and
apply (i) the modified graph as input to an anomaly detector comprising a graph neural network and (ii) the labeled data as training data to the anomaly detector.

16. A non-transitory computer-readable medium having instructions stored thereon, wherein execution of the instructions causes a processor to:
receive data for a network system;
generate a graph using the data, wherein the graph contains a set of nodes connected by a set of edges as defined by the network system;
generate a modified graph for input to a trained anomaly detector by:
generating a set of average controllability score values for the set of nodes, wherein each node of the set of nodes is assigned a generated average controllability score value, and wherein each average controllability score value defines control influence of a respective node in the graph based on a Gramian operator;
generating one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node; and
assigning the set of average controllability score values for the set of nodes and the one or more encodings for the set of edges to the graph to generate a modified graph;
apply the modified graph as input to the trained anomaly detector comprising a graph neural network, wherein the trained anomaly detector is configured to detect an anomaly based on at least one of average controllability score and/or encoding, and wherein the anomaly indicates presence or non-presence of an anomaly in the network system; and
output an indication of an anomaly in the network system based on the output of the trained anomaly detector.

17. The non-transitory computer-readable medium of claim 16, wherein instructions to generate the edge weight values for the set of edges, when executed, cause the processor to:
adjust the set of generated average controllability score values using a scaling operator; and
determine a weight value for each edge in the set of edges using a controllability score value of a node of the edge.

18. The non-transitory computer-readable medium of claim 16, wherein instructions to generate the edge attributes for the set of edges, when executed, cause the processor to:
generate a histogram object corresponding to a distribution of occurrence of specific average controllability score values determined across a set of steps for at least a change in state transition assessed using the Gramian operator; and
determine an edge feature matrix for the set of edges by applying a rank encoding operator based on if the average controllability of one or more source nodes resides in a corresponding edge.

19. The non-transitory computer-readable medium of claim 16, wherein instructions to generate the set of controllability score values, when executed, cause the processor to:
determine an adjacency matrix object of the graph;
determine a largest absolute eigenvalue for the adjacency matrix object;
generate a normalized adjacency matrix object using the largest absolute eigenvalue and an identity matrix object; and
generate a controllability matrix object, wherein the controllability matrix object has diagonal entries forming the set of controllability score values.

20. The non-transitory computer-readable medium of claim 16, wherein instructions to generate the trained anomaly detector, when executed, cause the processor to:
receive a graph containing a set of nodes connected by a set of edges for a set of example network systems having labeled data associated with an anomaly;
generate a set of average controllability score values for the set of nodes, wherein each node of the set of nodes is assigned a generated average controllability score value, and wherein each average controllability score value defines control influence of a respective node in the graph based on a Gramian operator;
generate one or more encodings for the set of edges using the set of average controllability score values for the set of nodes, wherein the encoding includes at least one of (i) an edge weight value that corresponds to a distance from a node to a source node or (ii) an edge attribute that corresponds to a distribution of average controllability score for the node;
assign the set of average controllability score values for the set of nodes and the one or more encodings for the set of edges to the graph to generate a modified graph; and
apply (i) the modified graph as input to an anomaly detector comprising a graph neural network and (ii) the labeled data as training data to the anomaly detector.
